(19) United States
(12) Patent Application Publication
(10) Pub. No.: US 2016/0046732 A1
(43) Pub. Date: Feb. 18, 2016

(54) ASEPTIC POLYMERIC COMPOSITIONS AND METHODS OF USING THE SAME

(71) Applicant: EMPIRE TECHNOLOGY DEVELOPMENT LLC, Wilmington, DE (US)

(72) Inventors: Georgius Abidal ADAM, Edensor Park (AU); Araxi MAKARDECH, Edensor Park (AU)

(21) Appl. No.: 14/460,509

(22) Filed: Aug. 15, 2014

(51) Int. Cl. C08B 31/04; A01N 43/16

(52) U.S. Cl. CPC C08B 31/04; A01N 43/16

(57) ABSTRACT

Aseptic polymers, methods for their preparation, and uses are provided, which include, for example, as disinfectants and other uses.

### BACKGROUND

Povidone iodine (PVP—I) is the most commonly used aseptic reagent in medical applications, cosmetics, and in drug industries as a solution, additive or gel. Although it is widely used, there are concerns regarding its carcinogenic effects due to the use of n-vinyl pyrolidone in its preparation. Pharmaceutical grade polyvinyl pyrolidone is also costly at about US $10-$20 per kilogram.

Accordingly, there is a need for aseptic polymeric compositions that are safer and cheaper. The present disclosure overcomes at least some, or all of the disadvantages of previous compositions as well as provides other advantages as discussed herein.

### SUMMARY

Embodiments disclosed herein provided polymers of Formula (I) or (II)

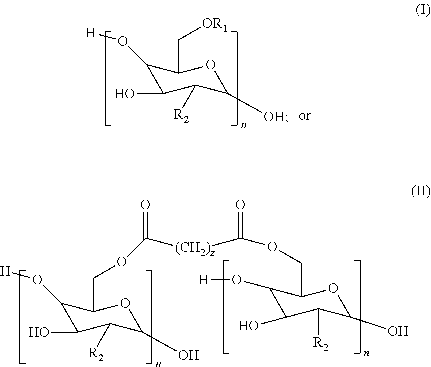

wherein:

R₁ is —C(═O)(CH₂)_{y}C(═O)OH; (CH₂)ₖCOOH or H;

R₂ is —OH, —NH₂, —NHCOOH, —NHCH₂OH, —N(CH₂OH)₂, or —NHR₃;

R₃ is H or

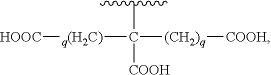

k is an integer from 1 to 11;

y is an integer from 1 to 11;

z is an integer from 1 to 11;

q is an integer from 1 to 15; and

n is an integer from 5 to 200,

provided that if R₂ is —OH or R₃ is H, then R₁ is —C(═O)(CH₂)_{y}C(═O)OH.

In some embodiments, the polymer is complexed iodine. In some embodiments the polymer complexed with iodine is aseptic.

In some embodiments, the polymer complexed with iodine has a formula of

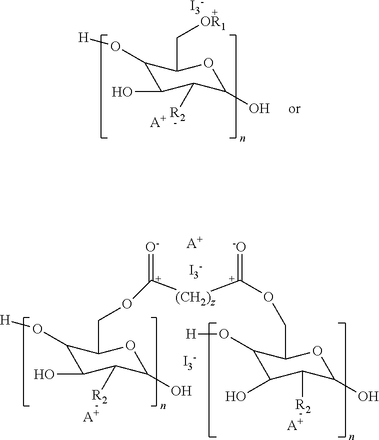

wherein A is a sodium ion or potassium ion.

In some embodiments, methods of preparing a polymer of Formula (I) are provided.

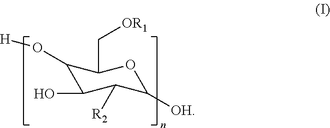

In some embodiments, the method comprises contacting a compound of Formula (III)

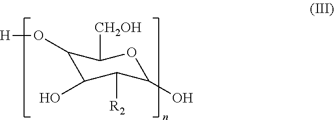

with a dicarboxylic acid in the presence of an acid catalyst under conditions sufficient to produce the polymer of Formula (I), wherein:
R₁ is —C(═O)(CH₂)_{y}C(═O)OH; (CH₂)ₖCOOH or H;

### R₂ is —OH, —NH₂, —NHCOOH, —NHCH₂OH, —N(CH₂OH)₂, or —NHR₃;

k is an integer from 1 to 11;

y is an integer from 1 to 11; and

n is an integer from 5 to 200. In some embodiments, the method further comprises contacting the polymer of Formula (I) with iodine and at least one iodide salt to produce an aseptic polymer.

In some embodiments, methods of preparing a polymer of Formula (Ia) are provided

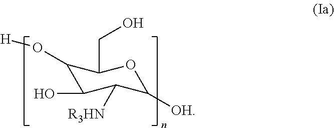

In some embodiments, the method comprises contacting a compound of Formula (IV)

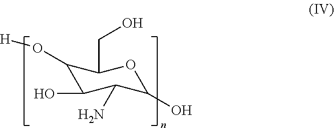

with a saturated dicarboxylic acid or a tricarboxylic acid under conditions sufficient to produce a compound of Formula (Ia), wherein:

R₃ is

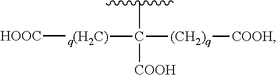

q is an integer from 1 to 15; and

n is an integer from 5 to 200. In some embodiments, the method comprises contacting the compound of (Ia) with iodine or iodine and iodide salt.

In some embodiments, methods of preparing a polymer of Formula (II) are provided

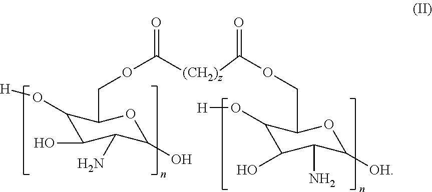

In some embodiments, the method comprises contacting a compound of Formula (IV)

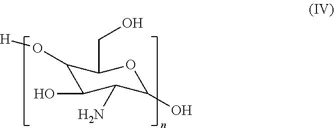

with a dicarboxylic acid or its acid chloride in the presence of an acid catalyst under conditions sufficient to produce the polymer of Formula (II), wherein z is an integer from 1 to 11 and each n is, independently, an integer from 5 to 200. In some embodiments, the method further comprises contacting the polymer of Formula (II) with iodine (I₂) or iodine and iodide salt.

Embodiments disclosed herein provide methods of disinfecting a surface, the method comprising contacting the surface with a polymer of Formula (I) complexed with iodine, or with a polymer of Formula (II) complexed with iodine

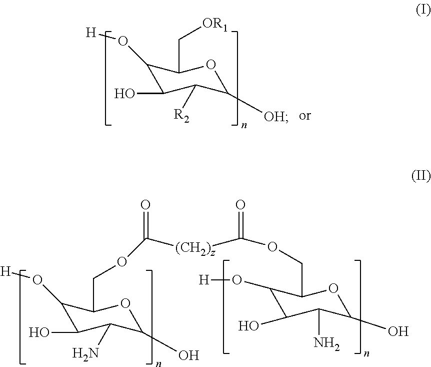

wherein:

R₁ is —C(═O)(CH₂)_{y}C(═O)OH; (CH₂)ₖCOOH or H;

R₂ is —OH, —NH₂, —NHCOOH, —NHCH₂OH, —N(CH₂OH)₂, or —NHR₃;

R₃ is

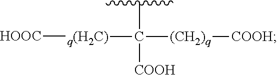

k is an integer from 1 to 11;

y is an integer from 1 to 11;

z is an integer from 1 to 11;

q is an integer from 1 to 15; and

n is an integer from 5 to 200,

provided that if R₂ is —OH or R₃ is H then R₁ is —C(═O)(CH₂)_{y}C(═O)OH.

Embodiments described herein provide methods of inhibiting bacterial growth, the method comprising contacting the bacteria with a polymer of Formula (I) or a polymer of Formula (I) complexed with iodine, or with a polymer of Formula (II) or a polymer of Formula (II) complexed with iodine

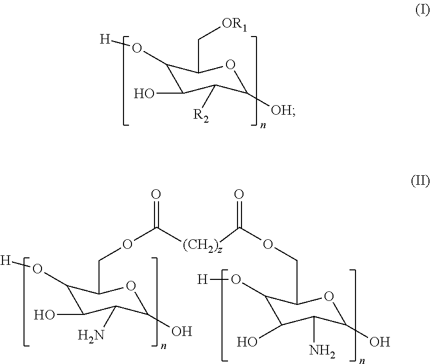

wherein:

R₁ is —C(═O)(CH₂)_{y}C(═O)OH; (CH₂)ₖCOOH or H;

R₂ is —OH, —NH₂, —NHCOOH, —NHCH₂OH, —N(CH₂OH)₂, or —NHR₃;

R₃ is

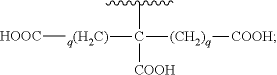

k is an integer from 1 to 11;

y is an integer from 1 to 11;

z is an integer from 1 to 11;

q is an integer from 1 to 15; and

n is an integer from 5 to 200,

provided that if R₂ is —OH or R₃ is H then R₁ is —C(═O)(CH₂)_{y}C(═O)OH. In some embodiments, the polymer complexed with iodine has a formula of:

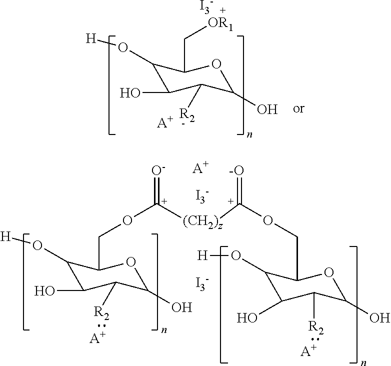

wherein A is a sodium ion or potassium ion.

Embodiments disclosed herein also provide kits comprising a first container comprising a polymer of Formula (I) or (II) complexed with iodine

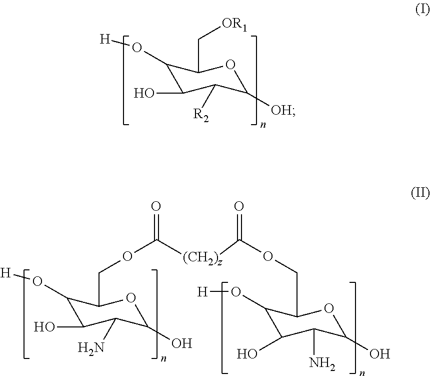

wherein:

R₁ is —C(═O)(CH₂)_{y}C(═O)OH; (CH₂)ₖCOOH or H;

R₂ is —OH, —NH₂, —NHCOOH, —NHCH₂OH, —N(CH₂OH)₂, or —NHR₃;

R₃ is H OR

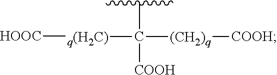

k is an integer from 1 to 11;

y is an integer from 1 to 11;

z is an integer from 1 to 11;

q is an integer from 1 to 15; and

n is an integer from 5 to 200,

provided that if R₂ is —OH or R₃ is H then R₁ is —C(═O)(CH₂)_{y}C(═O)OH; and optionally a second container comprising a sterilized solvent.

### BRIEF DESCRIPTION OF FIGURES

FIG. 1 illustrates a typical IR spectrum for corn starch and starch oxalate (red line) prepared according to Example 1.

FIG. 2 illustrates a typical thermogravimetric analysis for corn starch oxalate complexed with iodine.

### DETAILED DESCRIPTION

Embodiments disclosed herein provide polymers that can be used, for example, in aseptic compositions and can be used to disinfect surfaces and materials.

In some embodiments, a polymer of Formula (I) or (II) are provided

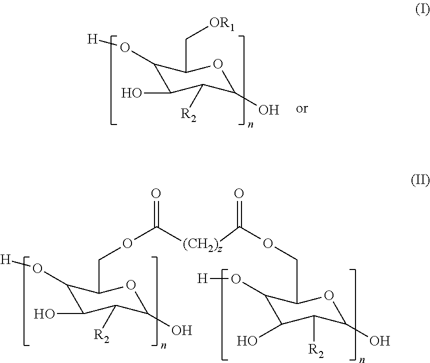

wherein:

R₁ is —C(═O)(CH₂)_{y}C(═O)OH; (CH₂)ₖCOOH or H;

R₂ is —OH, —NH₂, —NHCOOH, —NHCH₂OH, —N(CH₂OH)₂, or —NHR₃;

R₃ is H or

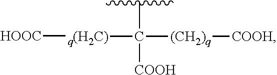

k is an integer from 1 to 11;

y is an integer from 1 to 11;

z is an integer from 1 to 11;

q is an integer from 1 to 15; and

n is an integer from 5 to 200.

In some embodiments, if R₂ is —OH or R₃ is H then R₁ is —C(═O)(CH₂)_{y}C(═O)OH. In some embodiments, R₂ is —NH₂, —NHCOOH, —NHCH₂OH, —N(CH₂OH)₂, or —NHR₃. In some embodiments of a compound of Formula II, R₂ is —NH₂.

In some embodiments, the polymer is aseptic. In some embodiments, the polymer is complexed with iodine. The polymer can be complexed with iodine by contacting the polymer with iodine or an iodine and iodide salt under conditions sufficient to produce a polymer complexed with the iodine.

In some embodiments, the polymer complexed with iodine has a formula of

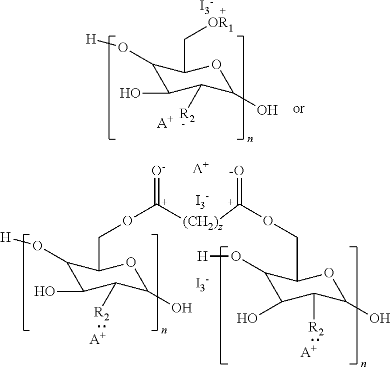

wherein A⁺ is a sodium or potassium ion. In some embodiments of the complex, R₂ is —NH₂.

In some embodiments, y is an integer from 1 to 2, 1 to 3, 1 to 4, 1 to 5, 1 to 6, 1 to 7, 1 to 8, 1 to 9, 1 to 10, 1 to 11, or an integer within any of these ranges (including endpoints). In some embodiments, y is an integer from 1 to 4.

In some embodiments, k is an integer from 1 to 2, 1 to 3, 1 to 4, 1 to 5, 1 to 6, 1 to 7, 1 to 8, 1 to 9, 1 to 10, 1 to 11, or an integer within any of these ranges (including endpoints). In some embodiments, k is an integer from 1 to 4.

In some embodiments, z is an integer from 1 to 2, 1 to 3, 1 to 4, 1 to 5, 1 to 6, 1 to 7, 1 to 8, 1 to 9, 1 to 10, 1 to 11, or an integer within any of these ranges (including endpoints). In some embodiments, z is an integer from 1 to 4.

In some embodiments, q is an integer from 1 to 2, 1 to 3, 1 to 4, 1 to 5, 1 to 6, 1 to 7, 1 to 8, 1 to 9, 1 to 10, 1 to 11, 1 to 12, 1 to 13, 1 to 14, 1 to 15, or an integer within any of these ranges (including endpoints). In some embodiments, q is 1.

In some embodiments, n is an integer from 5 to 20, 5 to 40, 5 to 60, 5 to 80, 5 to 100, 5 to 120, 5 to 140, 5 to 160, 5 to 180, 5 to 200, or an integer within any of these ranges (including endpoints).

In some embodiments, R₁ is —C(═O)(CH₂)_{y}C(═O)OH and R₂ is —OH. In some embodiments, R₃ is H. In some embodiments, R₃ is

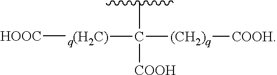

In some embodiments, if R₂ is —OH or R₃ is H then R₁ is —C(═O)(CH₂)_{y}C(═O)OH.

Embodiments for preparing a polymer of Formula (I)

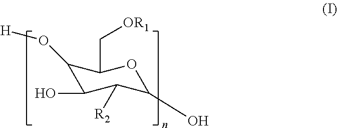

are also provided. In some embodiments, the method includes contacting a compound of Formula (III)

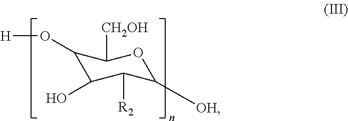

with a dicarboxylic acid (for example, a saturated dicarboxylic acid) in the presence of an acid catalyst under conditions sufficient to produce the polymer of Formula (I), wherein: R₁ is —C(═O)(CH₂)_{y}C(═O)OH; R₂ is —OH, NH₂; y is an integer from 1 to 11; and n is an integer from 5 to 200. In some embodiments, the polymer of Formula (I)-iodine complex is aseptic. In some embodiments, the polymer of Formula (I)-iodine complex is a controlled release aseptic agent.

Examples of dicarboxylic acids include, but are not limited to, a saturated dicarboxylic acid, saturated hydroxyl-dicarboxylic acid, saturated thiol-dicarboxylic acid, saturated keto-dicarboxylic acid, amino-dicarboxylic acid, or saturated tricarboxylic acid. Examples of saturated dicarboxylic acids include, but are not limited to, oxalic acid, succinic acid, malonic acid, glutaric acid, adipic acid, pimelic acid, suberic acid, azeliac acid, sebacic acid, undecanedioic acid, dodecanedioic acid, and the like. In some embodiments, the hydroxyl-dicarboxylic acid is malic acid. In some embodiments, the tricarboxylic acid is citric acid or tartaric acid. Other acids that fall within the classes described herein can also be used.

Many acid catalysts are suitable to be used in the preparation of the polymer of Formula (I). Examples include, but are not limited to, sulfuric acid, sulfonic acid, hydrochloric acid, and the like.

In some embodiments, the method comprises dissolving the carboxylic acid in a suitable solvent. Examples of a suitable solvent include, but are not limited to, DMSO. In some embodiments, the carboxylic acid is dissolved in the solvent and heated to a temperature of about 110-140 C. In some embodiments, the methods further include adding a pre-gelatinized starch to the heated solution. In some embodiments, the acid catalyst is added to the solution including the starch. In some embodiments, an organic solvent (for example, toluene and the like) is added to dissolve the formed starch monoester. In some embodiments, the formation of the esters is performed without an organic solvent. The esters can then be precipitated out and washed with ethanol to remove the unreacted carboxylic acid. The ester can also be dried.

In some embodiments, the methods of preparing the polymer of Formula (I) further comprises contacting the polymer of Formula (I) with iodine (I₂) in the presence of at least one iodide salt. Examples of iodide salts include, but are not limited to KI or NaI. In some embodiments, the method comprises dissolving the polymer of Formula (I) in an aqueous solution with the iodine and the iodide salt. In some embodiments, the reaction is stopped when the concentration of the free iodide reached less than about 0.6 w/v %. In some embodiments, the polymer complexed with iodine is dried. In some embodiments, the polymer is loaded with iodine to about 1-15%, 1-10%, 5-15%, 7-15%, 8-15%, 7-12% (w/w). In some embodiments, the polymer is loaded with iodine to about 1%, 2%, 3%, 4%, 5%, 6%, 7%, 8%, 9%, 10%, 11%, 12%, 13%, 14% or 15% (w/w).

Methods of preparing a polymer of Formula (Ia)

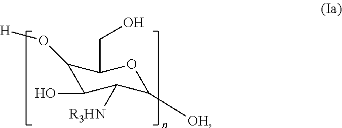

wherein:

### R₃ is

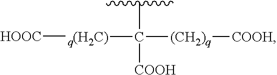

q is an integer from 1-15;
n is an integer from 5-200, are also provided. In some embodiments, the method includes contacting a compound of Formula (IV)

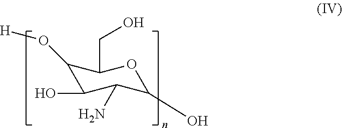

with a saturated dicarboxylic acid or a tricarboxylic acid under conditions sufficient to produce the polymer of Formula (Ia). As with the other polymers described herein, the polymer of Formula (Ia) iodine complex can be an aseptic polymer. An example of a suitable tricarboxylic acid includes, but is not limited to, citric acid. Other tricarboxylic acid can also be used. An example of a suitable saturated dicarboxylic acid includes, but is not limited to, malic acid. Other saturated dicarboxylic acid can also be used. Other examples are described herein and can be used.

The polymer of Formula (Ia) can also be complexed with iodine. Accordingly, in some embodiments, the method further includes contacting the polymer of Formula (Ia) with iodine (I₂) in the presence of an iodide salt. Examples of iodide salts include, but are not limited to, KI, NaI, and the like.

Embodiments disclosed herein also provided methods of preparing a polymer of Formula (II)

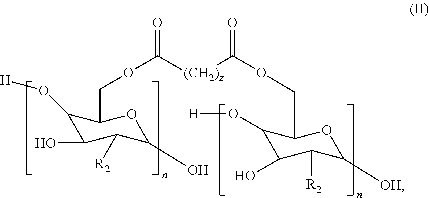

with variables as defined herein, wherein z is an integer from 1 to 11 and each n is, independently, an integer from 5 to 200. In some embodiments, the method includes contacting a compound of Formula (IV)

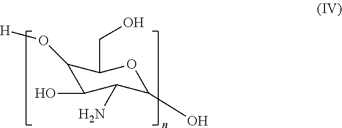

with a dicarboxylic acid in the presence of an acid catalyst under conditions sufficient to produce the polymer of Formula (II), wherein z is an integer from 1 to 11 and each n is, independently, an integer from 5 to 200. The polymer of formula (II) may be complexed with iodine. Accordingly, in some embodiments, the method further includes contacting the polymer of Formula (II) with (I₂) in the presence of an iodide salt. In some embodiments, the iodide salt is KI or Nat

Examples of suitable dicarboxylic acids that can be used in the preparation of the polymer of Formula (II) include, but are not limited to, a saturated dicarboxylic acid, saturated hydroxyl-dicarboxylic acid, saturated thiol-dicarboxylic acid, saturated keto-dicarboxylic acid, saturated amino-dicarboxylic acid, saturated tricarboxylic acid, and the like. Examples of a saturated dicarboxylic acid include, but are not limited to, oxalic acid, succinic acid, malonic acid, glutaric acid, adipic acid, pimelic acid, suberic acid, azeliac acid, sebacic acid, undecanedioic acid, dodecanedioic acid, and the like. An example of a hydroxyl-dicarboxylic acid includes, but is not limited to, malic acid. Examples of a tricarboxylic acid include, but are not limited to, citric acid or tartaric acid.

As discussed with reference to the preparation of other polymers described herein, any suitable acid catalyst can be used, including, but not limited to, sulfuric acid, sulfonic acid, or hydrochloric acid.

The present disclosure also provides methods of disinfecting a surface with any of the polymers disclosed herein. In some embodiments, a method of disinfecting a surface includes contacting the surface with any polymer or polymer complexed with iodine described herein. In some embodiments, the method comprises contacting the surface with a 0.1-1% solution of a polymer iodine complex described herein. In some embodiments, the surface is bathed in the solution for at least 30 seconds. In some embodiments, the method includes contacting a surface with a polymer of Formula (I)

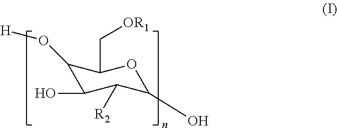

complexed with iodine or with a polymer of Formula (II) complexed with iodine

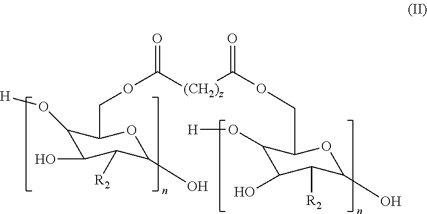

wherein:
R₁ is —C(═O)(CH₂)_{y}C(═O)OH; (CH₂)ₖCOOH or H;

### R₂ is —OH, —NH₂, —NHCOOH, —NHCH₂OH, —N(CH₂OH)₂, or —NHR₃;

### R₃ is H or

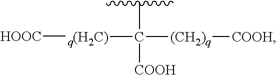

k is an integer from 1 to 11;
y is an integer from 1 to 11;
z is an integer from 1 to 11;
q is an integer from 1 to 15;
n is an integer from 5 to 200,
provided that if R₂ is —OH or R₃ is H then R₁ is —C(═O)(CH₂)_{y}C(═O)OH.

In some embodiments of the methods of disinfecting, the polymer complexed with iodine has a formula of:

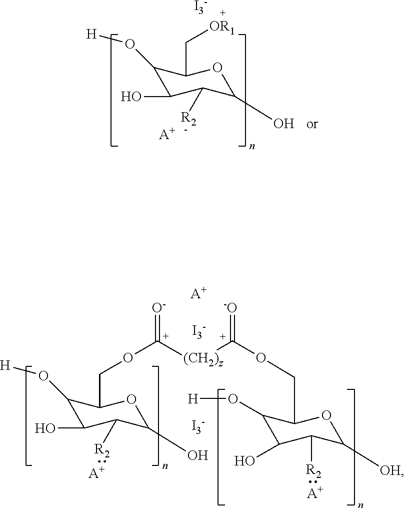

wherein A is a sodium ion or potassium ion and the other variables are as defined herein.

Examples of surfaces that can be disinfected with the polymers described herein include, but are not limited to, any one of skin (for example, non-human animal skin or human skin), plastic, rubber, or textiles. The skin can also have an abrasion or a wound that needs disinfecting. Examples of textiles include, but are not limited to, natural or synthetic textiles. Examples of textiles include, but are not limited to, cotton, nylon, polyester, rayon, combinations thereof, and the like.

The present disclosure also provides methods of inhibiting bacterial growth with any of the polymers disclosed herein. In some embodiments, a method of inhibiting bacterial growth includes contacting the bacteria with any polymer or polymer complexed with iodine described herein. In some embodiments, the method comprises the bacteria are contacted with a 0.1-1% solution of a polymer iodine complex described herein. In some embodiments, the bacteria is contacted with the solution for at least 30 seconds. In some embodiments, the method includes contacting a bacteria with a polymer of Formula (I)

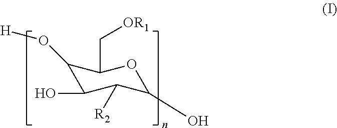

complexed with iodine or with a polymer of Formula (II) complexed with iodine

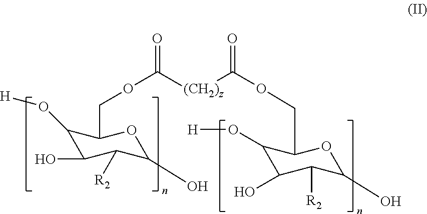

wherein:
R₁ is —C(═O)(CH₂)_{y}C(═O)OH; (CH₂)ₖCOOH or H;

### R₂ is —OH, —NH₂, —NHCOOH, —NHCH₂OH, —N(CH₂OH)₂, or —NHR₃;

### R₃ is H or

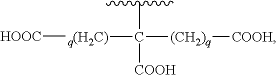

k is an integer from 1 to 11;
y is an integer from 1 to 11;
z is an integer from 1 to 11;
q is an integer from 1 to 15;
n is an integer from 5 to 200,
provided that if R₂ is —OH or R₃ is H then R₁ is —C(═O)(CH₂)_{y}C(═O)OH.

In some embodiments of the methods of inhibiting bacterial growth, the polymer complexed with iodine has a formula of:

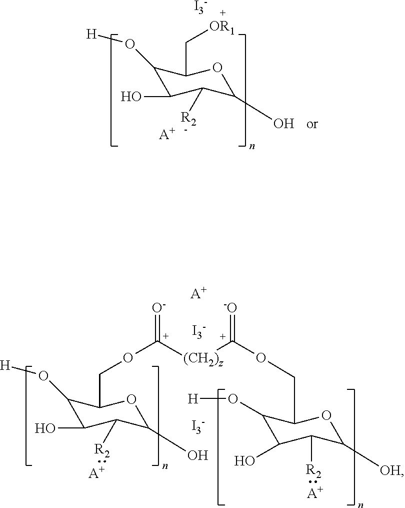

wherein A is a sodium ion or potassium ion and the other variables are as defined herein.

In some embodiments, the bacteria is gram positive or gram negative bacteria. In some embodiments, the bacteria is S. aureus. In some embodiments, the bacteria is E. coli. In some embodiments, the bacteria is P. aeruginosa. The results described herein demonstrate that the polymers described herein have the surprising result of being a broad bacterial spectrum inhibitor. Additionally, the results demonstrate the polymer itself has bactericidal properties.

The present embodiments also provide kits. The kits can, for example, include containers containing any of the polymers described herein that is or is not complexed with iodine. In some embodiments, the kit includes a first container, the first container can include a polymer of Formula (I) or (II) free or complexed with iodine.

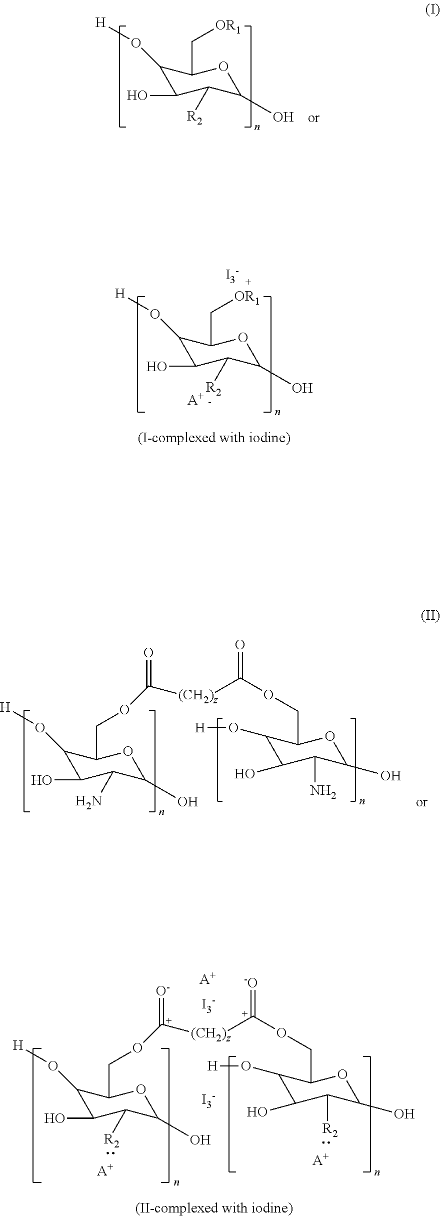

wherein:
R₁ is —C(═O)(CH₂)_{y}C(═O)OH; (CH₂)ₖCOOH or H;

### R₂ is —OH, —NH₂, —NHCOOH, —NHCH₂OH, —N(CH₂OH)₂, or —NHR₃;

### R₃ is

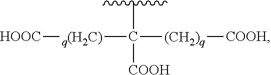

k is an integer from 1 to 11;
y is an integer from 1 to 11;
z is an integer from 1 to 11;
q is an integer from 1 to 15;
n is an integer from 5 to 200,
provided that if R₂ is —OH or R₃ is H then R₁ is —C(═O)(CH₂)_{y}C(═O)OH;

The kit can also include another container that protects the contents from light (for example, opaque or dark colored container) containing powder consisting partially cross-linked starch iodine complex of formula II. In some embodiments the kit includes a first container, the first container including a polymer of Formula (I) or (II) complexed with iodine as a fine powder. In some embodiments, the kit includes a second container. In some embodiments, the second container includes a sterilized solvent, such as, but not limited to, water, alcohol (for example, ethanol) or a mixture thereof. The kits can also include instructions for preparing the polymer complexed with iodine. In some embodiments, the kit includes other disinfectant solutions.

### EXAMPLES

### Example 1

### Preparation of a Starch Oxalate Monoester

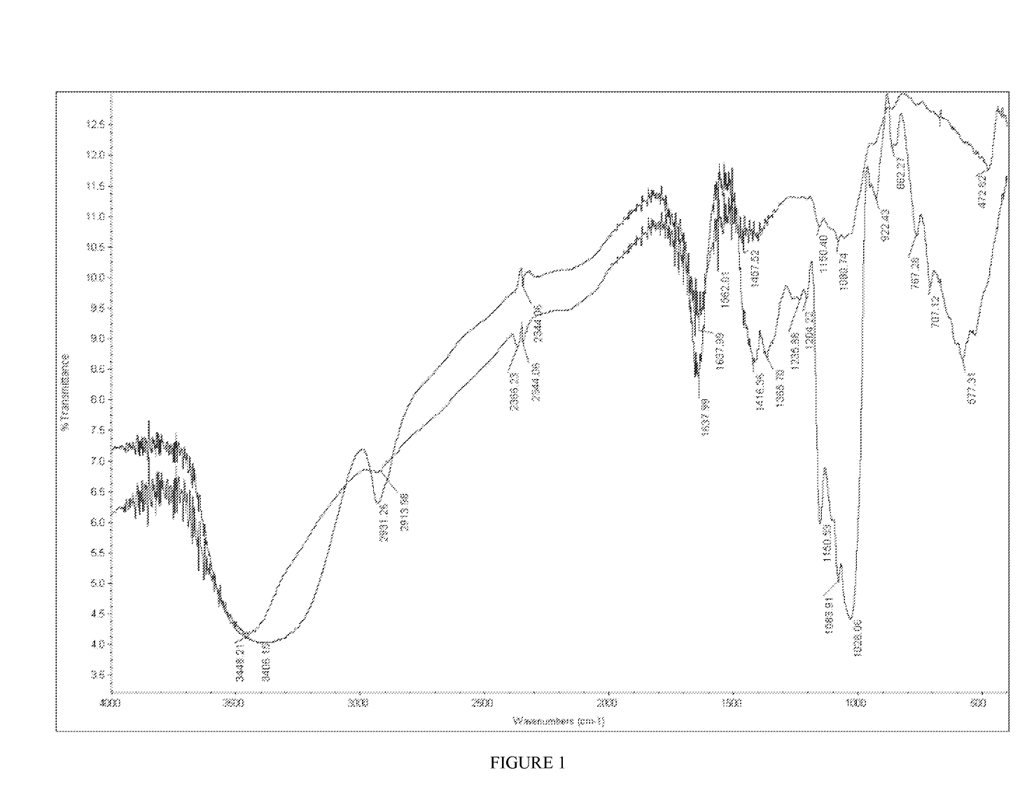

A 1 L reaction vessel fitted with a condenser immersed in oil bath at 120 C. was charged with 80 g of oxalic acid and was dissolved in 200 mL of DMSO. 50 g of the pre gelatinized corn starch was added with occasional stirring in the presence of 1% by weight of starch and concentrated sulfuric acid and the reaction was continued for 6 hours and then 100 mL of toluene was added to dissolve the formed starch mono ester. The mixture was refluxed for 10 hours with occasional shaking Molecular sieves pre-dried A4 were used as a moisture absorbing agent to force the equilibrium of the reaction for a higher degree of esterification. At the end of reaction time homogenous solutions were obtained and separated from molecular sieves by decantation. While hot, the solution was cooled and the starch mono esters and di-esters precipitated out or were re-precipitated by addition of acetone or acetone/water mixture. The precipitate was washed with 60% ethanol to remove the unreacted oxalic acid and dried. The degree of esterification was determined by titration. The product was characterized by IR. A typical spectrum is shown in FIG. 1, which demonstrates surprisingly the efficiency of this reaction and the ability to produce a starch oxalate monoester according to the methods described herein. The same experiment was carried out without using toluene and higher degree of ester formation was obtained and this product was transferred to iodine complexes as shown in Example 2.

### Example 2

### Preparation of Starch Oxalate Iodine Complexes

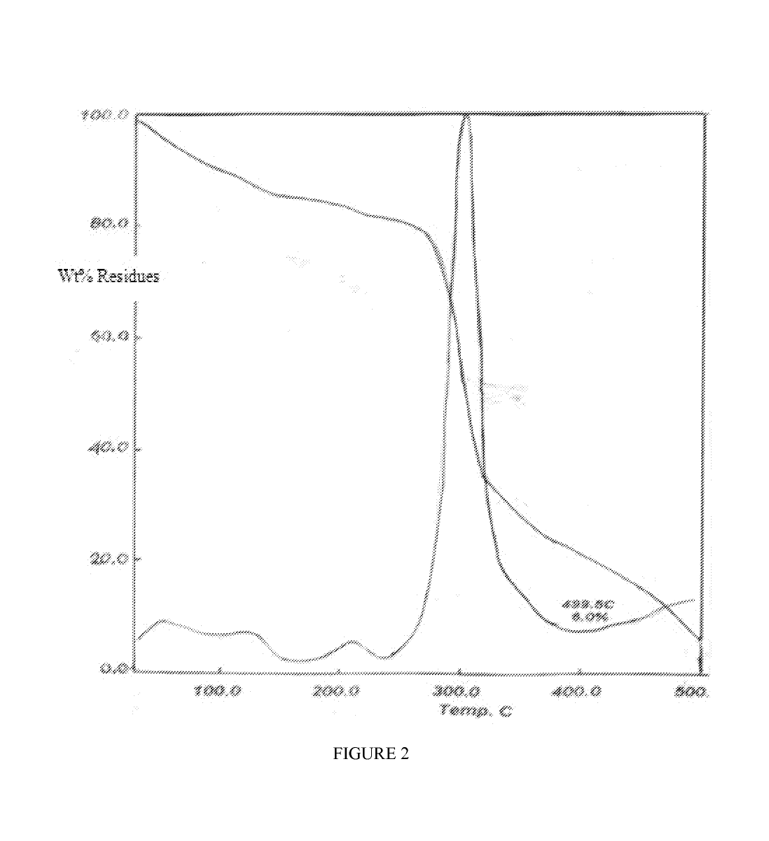

A reaction vessel fitted with stirrer, condenser and thermometer was charged with (25 g) of starch oxalate prepared according to Example 1 was dissolved in distilled water (100 g), iodine (2.5 g), and KI (2 g). The reaction mixture was stirred for 48 hrs. Fractions were taken from the reaction mixture at several intervals and analyzed for free iodine by titration. The reaction was stopped when the concentration of the free iodide reached less than 0.6% (w/v). At the end of the reaction time the solution was dried by rotary evaporator followed by vacuum at 50 C. for three hours. FIG. 2 illustrates a typical thermogravimetric analysis for corn starch oxalate showing loaded with iodine to 10.25% (w/w), which demonstrates the surprising results regarding the efficiency and amount of iodine that can be incorporated into the polymer thereby allowing it to be used as a novel aseptic reagent.

### Example 3

### Preparation of Starch Succinate Monoester

A 1 L reaction vessel fitted with a condenser immersed in oil bath at 120 C. is charged with 80 g of succinic acid and is dissolved in 200 mL of DMSO. 50 g of the pre gelatinized corn starch is added with occasional stirring in the presence of 1% by weight of starch and concentrated sulfuric acid and the reaction was continued for 6 hours and then 100 mL of toluene is added to dissolve the formed starch mono ester. The mixture is refluxed for 10 hours with occasional shaking Molecular sieves pre-dried A4 are used as a moisture absorbing agent to force the equilibrium of the reaction for a higher degree of esterification. At the end of reaction time homogenous solutions is obtained and separated from molecular sieves by decantation. While hot, the solution is cooled and the starch mono esters and di-esters precipitated out. The precipitate is washed with 60% ethanol to remove the unreacted succinic acid and dried. The degree of esterification is determined by titration. The succinate ester is complexed with iodine according to Example 2.

### Example 4

### Preparation of Starch Citrate Monoester Iodine Complexes

A 1 L reaction vessel fitted with a condenser immersed in oil bath at 120 C. is charged with 80 g of citrate acid and is dissolved in 200 mL of DMSO. 50 g of the pre-gelatinized corn starch is added with occasional stirring in the presence of 1% by weight of starch and concentrated sulfuric acid and the reaction is continued for 6 hours and then 100 mL of toluene is added to dissolve the formed starch mono ester. The mixture is refluxed for 10 hours with occasional shaking Molecular sieves pre-dried A4 are used as a moisture absorbing agent to force the equilibrium of the reaction for a higher degree of esterification. At the end of reaction time homogenous solutions is obtained and separated from molecular sieves by decantation. While hot, the solution is cooled and the starch mono esters and di-esters precipitated out. The precipitate is washed with 60% ethanol to remove the unreacted citric acid and dried. The degree of esterification is determined by titration. The citrate ester is complexed with iodine according to Example 2.

### Example 5

### Preparation of Starch Oxalate Iodine Complex by Using Oxalic Acid Chloride

A 1 L reaction vessel fitted with condenser and separating funnel immersed in a water bath at 30 C and is charged with 150 mL of DMSO. 50 g of the pre-gelatinized starch is added with efficient stirring under dry conditions. The solution of oxalic acid chloride is dissolved in DMSO and is added portion wise with efficient mixing over one hour. The reaction is continued for about 4 hours. The formed HCl by-product is capped from condenser and bubbled in 20% sodium hydroxide solution. The starch oxalate is complexed with iodine according to Example 2.

### Example 6

### Preparation of Starch Succinate Iodine Complex by Using Succinic Acid Chloride

A 1 L reaction vessel fitted with condenser and separating funnel immersed in an oil bath at 30 C. and is charged with 150 mL of DMSO. 50 g of the pre-gelatinized starch is added with efficient stirring under dry conditions. A solution of succinic acid chloride is prepared by dissolving it in DMSO and is then added portion wise with efficient mixing over one hour. The reaction is continued 4 hours. The formed HCl by-product is capped from condenser and bubbled in 20% sodium hydroxide solution. The starch succinate is complexed with iodine according to Example 2.

### Example 7

### Preparation of Chitosan Oxalate Iodine Complex by Using Oxalic Acid Chloride

A 1 L reaction vessel fitted with a condenser and separating funnel immersed in an oil bath at 30 C. is charged with 150 mL of DMSO 15 g of chitosan is added with efficient stirring under dry conditions and then added to the solution. 100 mL solution (25% by weight) of oxalic acid chloride in DMSO is added portion wise with efficient mixing over one hour. The reaction is continued for further hour. The formed HCl by product is capped from condenser and bubbled in 20% sodium hydroxide solution to be transferred to its salt. The obtained starch oxalate is transferred to its iodine complexes adopting the same procedure used in Example 1.

### Example 8

### Preparation of Corn Starch Oxalate Di-Ester Iodine Complex

The same procedure used in Example 5 was utilized for the preparation of starch di-oxalate ester.

### Example 9

### Wound Disinfection

A wound is disinfected with a polymer of the formula

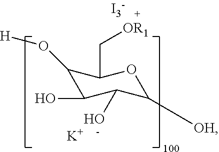

wherein R₁ is —C(═O)(CH₂)₄C(═O)OH by contacting the wound with a 0.1-1% solution of the polymer iodine complex. The wound is bathed in the solution for at least 30 seconds. The wound is found to be disinfected.

### Example 10

### Preparation of Partially Cross-Linked Starch Oxalate (Starch Half Oxalate)

Corn starch (30 g) was dissolved in DMSO (300 mL) with stirring in a 500 mL conical flask. Oxalic acid (11.6 g; 0.5 molar ratio of starch) was then added and stirred until dissolution. 60 mL of this mixture was taken out as control [starch half oxalate 0 h]. Concentrated sulfuric acid (0.3 mL) was then added to the mixture and the solution was heated to 115 C. 80 mL of the solution was collected after 1.5 and 3 h of heating and the reaction was stopped at 4.5 h of heating time. The products were isolated by precipitation in DCM/acetone or acetone to yield the products as off-white solids. (NB: starch half oxalate 1.5 h and 4.5 h samples were precipitated twice). The starch half oxalate product (0.20 g) was weighed accurately and dissolved in 15 mL of distilled water. 0.4474 M NaOH (5.0 mL) was then added to the solution and the mixture was stirred and heated at 50° C. for 30 min. The solution was kept at room temperature with shaking for 72 h. The excess NaOH was back-titrated against 0.1 M HCl using phenolphthalein as indicator. The degree of esterification was determined using the given equations and the results are shown in Table 1.

TABLE 1
Degree of esterification of starch half oxalate products.

| Duration of heating | |
|---|---|
| (hour) | Degree of esterification |
| 0 | 0.0182 |
| 1.5 | 0.358 |
| 3 | 0.442 |
| 4.5 | 0.445 |

The degree of esterification or the amount of oxalate on starch increases as the duration of the heating increases. At 1.5 h of heating time, the degree of esterification increased dramatically from 0.018 to 0.358. The degree of esterification increased even further to 0.442 after 3 h of heating, however a further heating of 1.5 h did not significantly increase the degree of esterification (0.445 at 4.5 h). The result suggests that 3 h of heating time is sufficient to provide a reasonable degree of esterification. To the starch half oxalate (0.5 g), Iodine and KI were added, followed by the addition of distilled water (15.0 mL). The reaction mixture was stirred at room temperature for 24 h. 1.0 mL aliquot of the solution was taken out, added with 0.1 M HCl (1 mL) and titrated against sodium thiosulphate (0.01 M) to determine the amount of free iodine), which was compared to Betadine® (povidone-iodine). The results are shown in Table 2.

TABLE 2

| | | | | Amount of | |
|---|---|---|---|---|---|
| | | Amount | Amount | available | Percentage |
| | | of | of KI | iodine (mg) | of |
| Sample | Starch | Iodine | added | per mL of | free iodine |
| No. | sample | added (g) | (g) | solution | (% w/v) |
| 1 | Untreated | 0.5 | 0.4 | 3.743 | 0.37 |
| | starch | | | | |
| 2 | Starch half | 0.5 | 0.4 | 2.569 | 0.26 |
| | oxalate 0h | | | | |
| 3 | Starch half | 0.5 | 0.4 | 4.948 | 0.49 |
| | oxalate 1.5h | | | | |
| 4 | Starch half | 0.5 | 0.4 | 3.775 | 0.38 |
| | oxalate 3h | | | | |
| 5 | Starch half | 0.075 | 0.06 | 6.535 | 0.65 |
| | oxalate 3h | | | | |
| 6 | Starch half | 0.5 | 0.4 | 4.504 | 0.45 |
| | oxalate 4.5h | | | | |
| 7 | Betadine | — | — | 16.4 | 1.64 |
| | (PVP-I) | | | | |

Among the samples that had the same amount of added Iodine and KI (samples 1-4 and 6), starch half oxalate 1.5 h and 4.5 h samples had the highest amounts of available iodine (0.49 and 0.45% w/v respectively), while the 3 h sample showed a comparatively low amount of free iodine (0.38% w/v). This could be due to the quality of the starch oxalate product, as the 3 h sample was precipitated once instead of twice for the 1.5 h and 4.5 h samples. The commercial antiseptic Betadine was found to have an available iodine content of 1.64% w/v. For the sample loaded with extra Iodine and KI (sample 5), the amount of available iodine was significantly higher. This suggests that the amount of available iodine can be adjusted by the amount of added Iodine and KI.

Antibacterial activity of the starch half oxalate-iodine complex was analyzed. Overnight cultures of bacteria (Staphylococcus aureus 38, Escherichia coli 008, Pseudomonas aeruginosa 01 and P. aeruginosa 6294) were prepared in Tryptone soya broth (TSB), and were spread onto nutrient agar plates by cotton swabs. 6 mm paper discs were then placed onto the agar plates followed by addition of samples onto the paper discs (10.0 μL). The plates were incubated at 37° C. for 24 h, and the zones of inhibition were measured. The results are shown in Table 3.

TABLE 3
Zone of inhibition diameter (mm)

| | S. | E. | P. | P. |
|---|---|---|---|---|
| | aureus | coli | aeruginosa | aeruginosa |
| Sample | 38 | 008 | 01 | 6294 |
| 1) Untreated starch | 10 | 9 | 8 | 8 |
| 2) Starch half oxalate 0h | 10 | 9 | 8 | 8 |
| 3) Starch half oxalate 1.5h | 19 | 16 | 11 | 11 |
| 4) Starch half oxalate 3h | 21 | 16 | 13 | 13 |
| 5) Starch half oxalate 3h | 25 | 20 | 17 | 16 |
| 1.5x extra I₂ and KI | | | | |
| 6) Starch half oxalate 4.5h | 21 | 15 | 12 | 12 |
| 7) Betadine (PVP-I) | 18 | 12 | 12 | 12 |

For the same amount of iodine loading, the control (untreated starch) and process control (starch half oxalate 0 h) showed only small zones of inhibition for all tested bacteria, whereas all the starch half oxalate-iodine complexes (samples 3, 4 and 6) exhibited relatively larger zones of inhibition. There was no significant difference in activity between the oxalate 1.5 h, 3 h and 4.5 h samples.

The starch oxalate-iodine complexes (samples 3, 4 and 6) exhibited higher or similar activity when compared to the commercial antiseptic Betadine, even though the amount of available iodine was 3-4 times higher for the Betadine. This indicates that the antiseptic activity of a material is not solely dependent on the amount of available iodine, and that the carrier (that complex with iodine) also plays a role. Accordingly, these results demonstrate the surprising results that the compounds described herein have superior antiseptic properties.

With extra loading of Iodine and KI (sample 5), the sample exhibited even bigger zones of inhibition for all bacteria. This again suggests that the antiseptic activity of the complex can be adjusted by the controlling the amount of added Iodine and KI.

The starch oxalate-iodine complexes exhibited highest activity against the Gram-positive bacterium S. aureus, followed by the Gram-negative bacteria E. coli and P. aeruginosa. There was no difference in activity between the difference strains of P. aeruginosa. The results indicated that the modification of starch by oxalic acid was successful and that the products were effective against a broad range of bacteria.

These examples demonstrate the unique and surprising results of the novel and non-obvious polymers that can be used as disinfectants and as an aseptic polymer.

This description is not limited to the particular processes, compositions, or methodologies described, as these may vary. The terminology used in the description is for the purpose of describing the particular versions or embodiments only, and it is not intended to limit the scope of the embodiments described herein. Unless defined otherwise, all technical and scientific terms used herein have the same meanings as commonly understood by one of ordinary skill in the art. In some cases, terms with commonly understood meanings are defined herein for clarity and/or for ready reference, and the inclusion of such definitions herein should not necessarily be construed to represent a substantial difference over what is generally understood in the art. However, in case of conflict, the patent specification, including definitions, will prevail.

It must also be noted that as used herein and in the appended claims, the singular forms “a”, “an”, and “the” include plural reference unless the context clearly dictates otherwise.

As used in this document, terms “comprise,” “have,” and “include” and their conjugates, as used herein, mean “including but not limited to.” While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting.

1. A polymer of Formula (I) or (II) 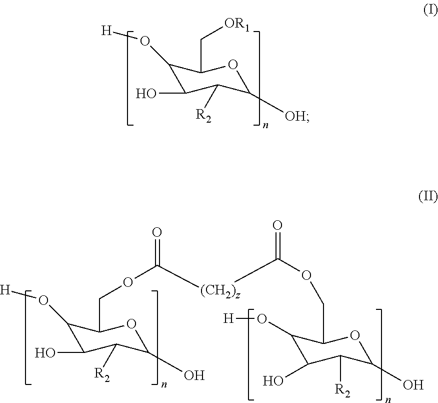
wherein:
R₁ is —C(═O)(CH₂)_{y}C(═O)OH; (CH₂)ₖCOOH or H;
R₂ is —OH, —NH₂, —NHCOOH, —NHCH₂OH, —N(CH₂OH)₂, or —NHR₃;
R₃ is H or 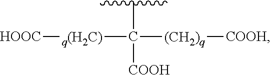
k is an integer from 1 to 11;
y is an integer from 1 to 11;
z is an integer from 1 to 11;
q is an integer from 1 to 15; and
n is an integer from 5 to 200,
provided that if R₂ is —OH or R₃ is H, then R₁ is —C(═O)(CH₂)_{y}C(═O)OH.

2. The polymer of claim 1, wherein the polymer complexed iodine is aseptic.

3. The polymer of claim 1, wherein the polymer is complexed with iodine.

4. The polymer of claim 3, wherein the polymer complexed with iodine has a formula of 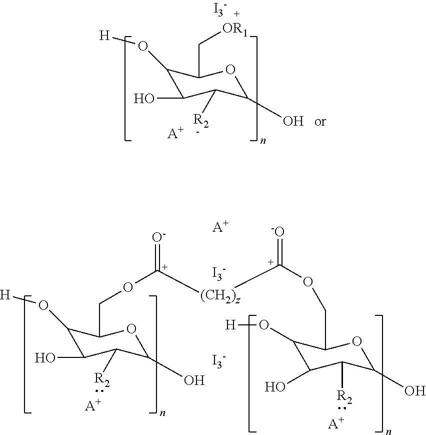
wherein A is a sodium ion or potassium ion.

5. The polymer of claim 1, wherein y is an integer from 1 to 4.

6. The polymer of claim 1, wherein z is an integer from 1 to 4.

7. A method of preparing a polymer of Formula (I) 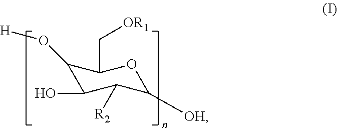
the method comprising:
contacting a compound of Formula (III) 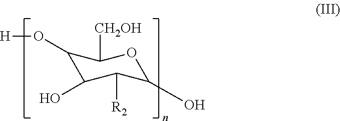
with a dicarboxylic acid in the presence of an acid catalyst under conditions sufficient to produce the polymer of Formula (I), wherein:
R₁ is —C(═O)(CH₂)_{y}C(═O)OH; (CH₂)ₖCOOH or H;
R₂ is —OH, —NH₂, —NHCOOH, —NHCH₂OH, —N(CH₂OH)₂, or —NHR₃;
k is an integer from 1 to 11;
y is an integer from 1 to 11; and
n is an integer from 5 to 200.

8. The method of claim 7, further comprising contacting the polymer of Formula (I) with iodine and at least one iodide salt to produce an aseptic polymer.

9. (canceled)

10. The method of claim 10, wherein the iodide salt is KI or NaI.

11. The method of claim 7, wherein the dicarboxylic acid is a saturated dicarboxylic acid, saturated hydroxyl-dicarboxylic acid, thiol-dicarboxylic acid, saturated keto-dicarboxylic acid, saturated amino-dicarboxylic acid, or saturated tricarboxylic acid.

12-14. (canceled)

15. The method of claim 7, wherein the acid catalyst is sulfuric acid, sulfonic acid, or hydrochloric acid.

16. A method of preparing a polymer of Formula (Ia) or Formula (II) 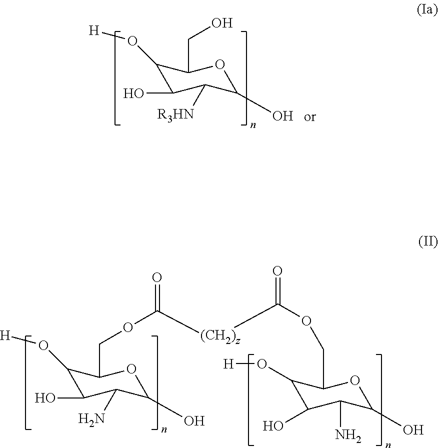
the method of preparing a polymer of Formula (Ia) comprising:
contacting a compound of Formula (IV) 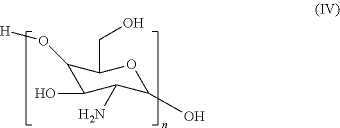
with a saturated dicarboxylic acid or a tricarboxylic acid under conditions sufficient to produce a compound of Formula (Ia), wherein:
R₃ is 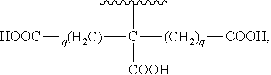
q is an integer from 1 to 15; and
n is an integer from 5 to 200; or
the method of preparing a polymer of Formula (II) comprising contacting a compound of Formula (IV) 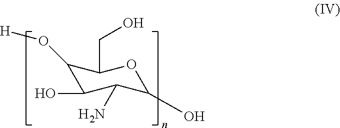
with a dicarboxylic acid or its acid chloride in the presence of an acid catalyst under conditions sufficient to produce the polymer of Formula (II), wherein z is an integer from 1 to 11 and each n is, independently, an integer from 5 to 200.

17-19. (canceled)

20. The method of claim 16, comprising contacting the compound of (Ia) or the compound of (II) with iodine and an iodide salt.

21. The method of claim 20, wherein the iodide salt is KI or NaI.

22-28. (canceled)

29. The method of claim 16, wherein the acid catalyst is sulfuric acid, sulfonic acid, or hydrochloric acid.

30. A method of disinfecting a surface or inhibiting bacterial growth, the method comprising contacting the bacteria, the method comprising contacting the surface or the bacteria with a polymer of Formula (I) or a polymer of Formula (I) complexed with iodine, or with a polymer of Formula (II) or a polymer of Formula (II) complexed with iodine 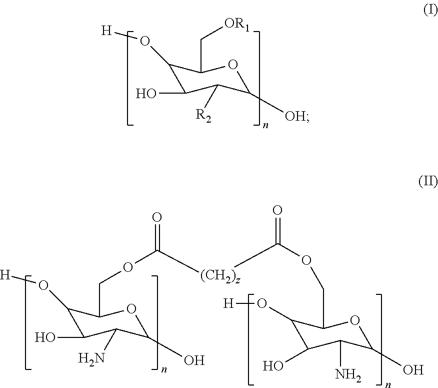
wherein:
R₁ is —C(═O)(CH₂)_{y}C(═O)OH; (CH₂)ₖCOOH or H;
R₂ is —OH, —NH₂, —NHCOOH, —NHCH₂OH, —N(CH₂OH)₂, or —NHR₃;
R₃ is 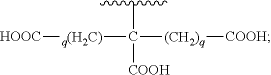
k is an integer from 1 to 11;
y is an integer from 1 to 11;
z is an integer from 1 to 11;
q is an integer from 1 to 15; and
n is an integer from 5 to 200,
provided that if R₂ is —OH or R₃ is H then R₁ is —C(═O)(CH₂)_{y}C(═O)OH.

31. The method of claim 30, wherein the polymer complexed with iodine has a formula of: 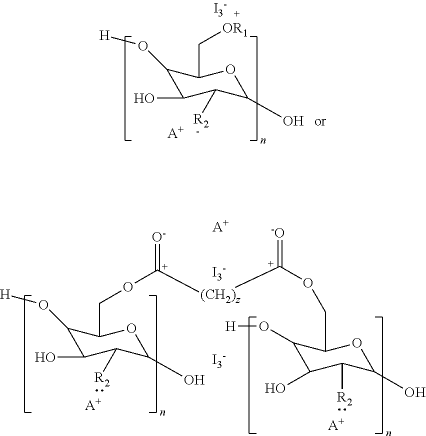
wherein A is a sodium ion or potassium ion.

32. The method of claim 30, wherein the surface is skin.

33. (canceled)

34. The method of claim 30, wherein the surface is plastic, rubber, textile, an abrasion or wound.

35. (canceled)

36. The method of claim 30, wherein the compound is a formula of 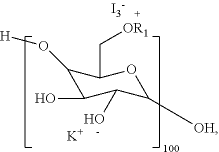
wherein R₁ is —C(═O)(CH₂)₄C(═O)OH.

37-43. (canceled)
